(19) United States
(12) Patent Application Publication
(10) Pub. No.: US 2008/0187276 A1
(43) Pub. Date: Aug. 7, 2008

(54) Flexible optical fiber tape and distribution cable assembly using same

(76) Inventors: Reginald Roberts, Taylorsville, NC (US); Jorge Roberto Serrano, Tokyo (JP); Timothy Frederick Summers, Hickory, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/710,322

(22) Filed: Feb. 23, 2007

Related U.S. Application Data
(60) Provisional application No. 60/899,158, filed on Feb. 2, 2007.

(51) Int. Cl. G02B 6/44

(52) U.S. Cl. 385/114

(57) ABSTRACT

A flexible optical fiber tape is formed from a substrate in the form of a strip adapted to maintain at least one optical fiber. The substrate may include an adhesive layer on at least one side for securing the tape to an external surface such as an interior floor, wall or ceiling. The tape may also have a flame-retardant characteristic. The optical fiber can run substantially longitudinally along the substrate, or can have one or more curved sections that allow for bending the tape without a substantially bending the at least one optical fiber. The tape may also include one or more network access points (NAPs) adapted to allow for optical communication between at least one external optical fiber and the at least one optical fiber maintained by the substrate. A distribution cable based on the optical-fiber-based tape is also described.

### RELATED APPLICATIONS

The present application claims priority to the provisional application filed on Feb. 2, 2007 and titled on the front page “Flexible Optical Fiber Tape and Distribution Cable Assembly Using Same” and having the inventive entity of Reginald Roberts and Jorge Roberto Serrano.

### BACKGROUND OF THE INVENTION

1. Field of the Invention

The present invention relates generally to optical fibers and optical fiber cables, and in particular to a flexible optical fiber tape having robust material properties and features that make it suitable for both indoor and outdoor use, and a distribution cable assembly based on the flexible optical fiber tape.

2. Technical Background

Optical fiber is increasingly being used for a variety of broadband communications including voice, video and data transmissions. As a result of the increasing demand for broadband communications, fiber optic networks typically include distribution cables having network access points (NAPs), also referred to herein as “mid-span access locations” or “tap points,” at which at least one optical fiber is preterminated, branched and spliced or otherwise optically connected to at least one external optical fiber, such as an optical fiber of a tether or drop cable. NAPs may be used to provide a number of branches off of the distribution cable and are being used to extend optical networks to an increasing number of subscribers. Such fiber optic networks are commonly referred to as “FTTx” networks, where “FTT” stands for “Fiber-to-the” and “x” generically describes an end location. While there has been an increase in the development of outdoor distribution cables that satisfy outdoor installation and environmental requirements, such cables are not suitable for indoor applications and environments, such as multi-dwelling unit (MDU) applications for FTTH (“Fiber-to-the-home) networks.

### SUMMARY OF THE INVENTION

In various embodiments, the present invention provides a flexible, optical-fiber-based tape particularly suited for but not limited to indoor applications wherein the optical fiber need not or cannot be hidden from view in a building's infrastructure. The tape may optionally include a fire-retardant substrate in the form of a strip having a central longitudinal axis and opposing upper and lower surfaces. At least one optical fiber is maintained by the substrate, e.g., either between the upper and lower surfaces, or attached to the upper or lower surface. The optical fiber can run substantially parallel to the central longitudinal axis, or can follow a curved path having curved sections for reducing the degree of bending of the optical fiber when the tape is bent. The tape may also include one or more adhesive layers formed respectively on one or both of the upper and lower surfaces (i.e., the outer surfaces). The adhesive layer is used for adhering the tape to an exterior surface, such as a floor, wall or ceiling. Where the tape has a plurality of optical fibers the spacing among one or more optical fibers is optionally such that easy separation of one or more substrates is possible to separate one or more optical fibers from the tape.

In various embodiments, the present invention further includes a distribution cable assembly that includes the above-described optical-fiber-based tape. The distribution cable assembly further includes, for example, at least one network access point (NAP) for routing an optical fiber from the cable assembly. The NAP may also include structures such as a fusion-splice to an external optical fiber, one or more connectors attached to respective optical fibers, an optical fiber tap, or the like. For instance, the NAP may allow for optical communication between at least one external optical fiber and the at least one optical fiber maintained by the substrate.

Additional features and advantages of the invention are set out in the detailed description which follows, and will be readily apparent to those skilled in the art from that description or recognized by practicing the invention as described herein, including the detailed description which follows, the claims, as well as the appended drawings. The phrases “upper” and “lower” are used in the drawings for the sake of reference and refer to orientation shown in the particular Figure, and thus are not intended as limiting. Also, a cross-sectional view that shows that apparatus along its longitudinal direction is referred to herein as a “longitudinal cross-sectional view.”

### BRIEF DESCRIPTION OF THE DRAWINGS

FIG. 1 is a schematic perspective view of a portion of a generalized optical-fiber-based tape apparatus according to the present invention generally illustrating the tape's shape and flexibility;

FIG. 2A is a cross-sectional view of an example embodiment of the tape of FIG. 1 taken along the line 2-2, wherein the optical fibers are maintained within the substrate upper and lower surfaces;

FIGS. 2B-2E are cross-sectional views similar to FIG. 2A, illustrating other example embodiments of the present invention;

FIG. 3 is a longitudinal cross-sectional view of an example embodiment of the tape of FIG. 2A taken along the line 3-3, wherein the optical fibers run substantially parallel to the central longitudinal axis of the tape;

FIG. 4 is a longitudinal cross-section view of the tape of the present invention similar to that shown in FIG. 2, illustrating another example embodiment of the tape that includes one or more strength members that provide mechanical protection for the one or more optical fibers in the tape;

FIG. 5 is a longitudinal cross-sectional view of the tape of FIG. 4, taken along the line 5-5 therein, illustrating an example embodiment wherein the one or more strength members run substantially parallel to central longitudinal axis of the tape;

FIG. 6 is a longitudinal cross-sectional view similar to that of FIG. 5, but illustrating an example embodiment of the tape wherein the one or more strength members each have gaps located along corresponding “fold” lines perpendicular to the central longitudinal axis;

FIG. 7 is a cross-sectional view similar to that of FIG. 4, but illustrating an example embodiment wherein the tape has a single optical fiber.

FIG. 8 is a longitudinal cross-sectional view taken along the line 8-8 in FIG. 7, illustrating an example embodiment of the tape wherein the single optical fiber has a curved path;

FIG. 9 is a schematic plan view of two intersecting walls that form an outside corner, along with the tape of FIG. 8 arranged on one of the walls so that a select section of the optical fiber curved path falls on the corner;

FIG. 10 is the same view as FIG. 9, but showing the tape wrapped around the outside corner, and wherein the optical fiber within the tape runs generally parallel to the corner rather than being bent around it;

FIG. 11 is a longitudinal cross-sectional view similar to that of FIG. 8, but showing the tape adhered to a flat wall and folded at 45 degrees along a curved section of the optical fiber curved path to form a right-angle bend in the tape on the flat wall without forming a sharp bend in the optical fiber;

FIG. 12 is a schematic plan view of an example distribution cable assembly based on the tape of the present invention illustrating a number of different network access points (NAPs);

FIG. 13 is a plan view of an example embodiment depicting the tape being connectorized at an end portion;

FIG. 14 is an end-on view of an example connector of FIG. 13, showing a multi-fiber connector;

FIG. 15 is a perspective view of an example embodiment of a layered tape apparatus according to the present invention;

FIG. 16 is a perspective view of an example embodiment of a tape apparatus that is detachable along the longitudinal axis according to the present invention;

FIG. 17 is a schematic diagram illustrating a cross-section of a bend-performance optical fiber operable in accordance with the embodiments of the present invention; and

FIG. 18 is a cross-sectional image of a microstructured bend-performance optical fiber illustrating an annular hole-containing region comprised of non-periodically disposed holes.

FIG. 19 is a perspective view of a tape apparatus that is packaged for use by the craft according to the present invention;

### DETAILED DESCRIPTION OF THE INVENTION

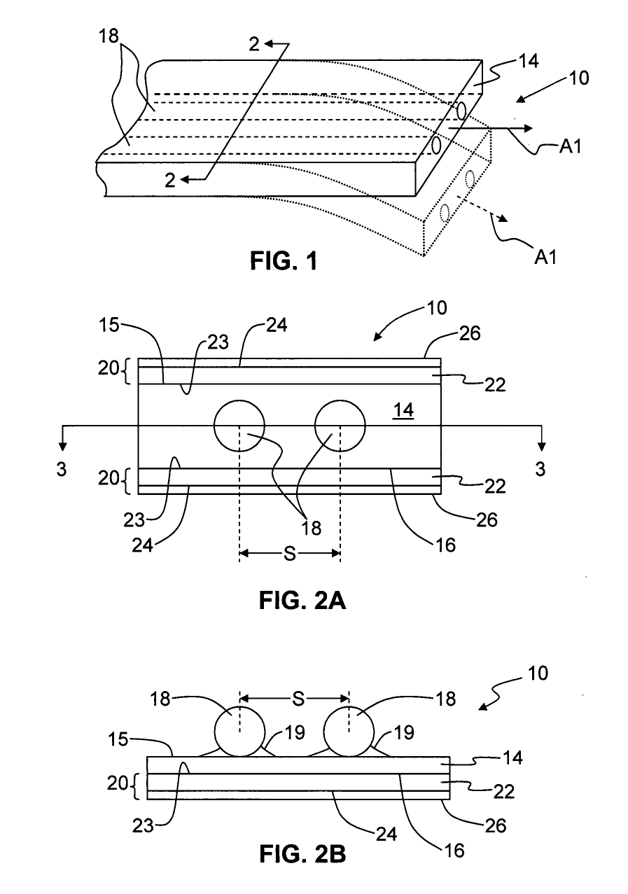

The present invention provides various embodiments of an optical fiber tape assembly for both indoor and outdoor applications. FIG. 1 is a perspective view of a portion of a generalized optical-fiber-based tape apparatus (“tape”) 10, illustrating the tape's flexibility as depicted by the dotted lines. Tape 10 has a longitudinal axis A1 that runs down the center of the tape in the longitudinal direction and includes at least one optical fiber 18 that runs along a length of a substrate 14. Tape 10 is shown as having an end with a generally rectangular cross-section, but other shapes are possible. Generally speaking, the cross-section of tape 10 has a height that is smaller than its width. Moreover, depending on its construction such as optical fiber count, materials, and the like, tape 10 can be relatively narrow or up to several centimeters wide.

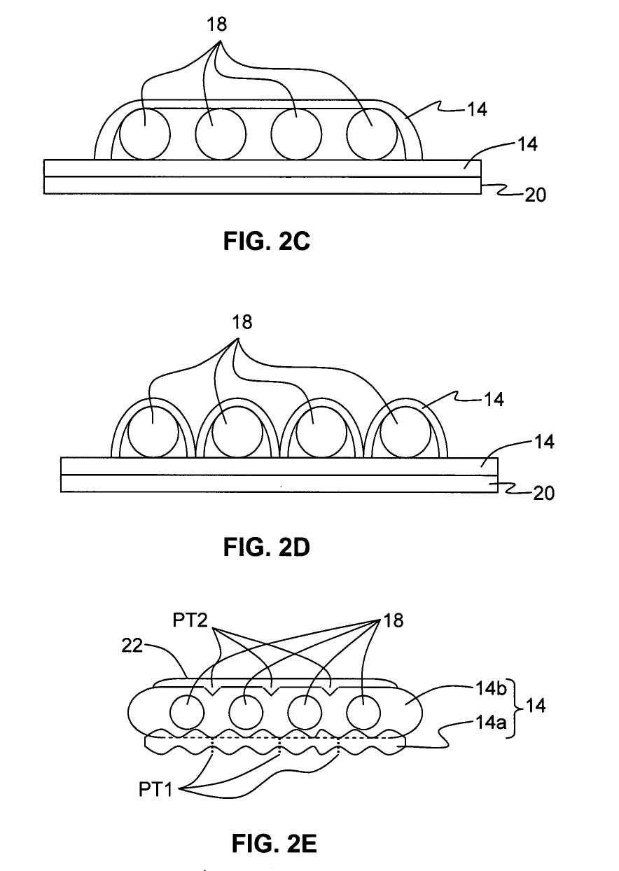

FIG. 2A is a cross-sectional view of the explanatory embodiment of tape 10 taken along the line 2-2 of FIG. 1. Tape 10 of FIG. 2 includes substrate 14 in the form of a strip and having an upper surface 15 and an opposing lower surface 16. As shown, substrate 14 maintains at least one optical fiber 18. In an example embodiment, substrate 14 is or includes one or more layers of any suitable material such as mylar, paper, plastic, fabric, mesh, strands, rovings, cellophane, vinyl, UV curable material or the like. For instance, a substrate could be a composite of a fabric or mesh and a UV curable material. Optionally, substrate 14 can include one or more flame-retardant materials as discussed in greater detail below, thereby meeting the desired flame-retardant rating. Additionally, optical fiber 18 may be any suitable type of optical fiber such as a tight-buffered optical fiber, an upcoated optical fiber, multiple optical fiber groups, or the like; however, individual optical fibers are depicted for simplicity.

As depicted in FIG. 2A, the at least one optical fiber 18 is maintained between its upper and lower surfaces. However, other constructions are possible with the concepts of the present invention. For instance, FIG. 2B depicts optical fibers 18 attached to substrate 14 and thus resides upon upper surface 15. Optical fibers 18 are attached to substrate upper surface 15 via an adhesive 19 such as a glue, hot melt adhesive, UV curable material, or the like. Additionally, optical fibers 18 are shown having a predetermined spacing S between centers, thereby allowing optional separation of a portion of substrate 14 while easily maintaining each of optical fiber attached to separate portions of substrate 14. Consequently, one or more optical fibers can be distributed at a network access point (NAP) as desired. By way of example, the predetermined spacing S of optical fibers 18 is about 1 millimeter or more, such as 3 millimeters or more, thereby making separation and handling of the portions easier by the craft. FIG. 2C depicts another tape where two substrates 14 have optical fibers 18 disposed therebetween. FIG. 2D is still another variation using two substrates 14 for forming individual chambers for optical fibers 18. Additionally, substrate 14 can be formed from a composite of two or more dissimilar materials. For instance, FIG. 2E depicts another tape having optical fibers 18 on a first substrate material 14a such as a fabric, mesh or the like and then having a second substrate material 14b such as a UV curable material, polymer or the like is disposed thereon. Additionally, an adhesive portion 22 is disposed on one or more sides for adhering tape 10 to an external surface. As shown, second substrate material 14b encapsulates the optical fibers 18, but not first substrate material 14a. Furthermore, the first substrate material is mesh, fabric, or the like and has one or more preferential tear characteristics PT1 along its length where it is easier to tear, thereby providing optical fibers 18 at network access points. Additionally, the second substrate material could also optionally include stress concentrators for providing preferential tear characteristics PT2 by altering its shape such as using notches or the like for influencing the initiation of fracture during separation of the tape. Variations of the composite substrate could encapsulate the other portions of the substrate and/or not encapsulate the optical fibers. Other variations include adding strength components and/or using the tape as a portion of larger assemblies having network access points are possible.

With reference again to FIG. 2A, in an example embodiment, tape 10 includes one or more adhesive layers 20 on substrate upper surface 15 and/or on substrate lower surface 16. Adhesive layer 20 is useful for adhering the tape to an external surface such as a wall, ceiling, or the like. The phrase “external surface” is used herein to distinguish from the upper and lower surfaces of the substrate, although as discussed below, the adhesive layer(s) can be used to form a layered tape structure (i.e., attaching multiple tapes together). Suitable materials for adhesives include glue, contact cement, pressure sensitive adhesives, thermoset adhesives, thermoplastic adhesives, radiation-curable adhesives, or the like. In one example embodiment, adhesive layer 20 is applied to upper and/or lower surfaces 15 and 16 in a form that is immediately adhesive such as a glue, contact cement, or the like. In another example embodiment, adhesive layer 20 is provided to upper and/or lower surfaces 15 and 16 is a form that is initially non-adhesive and that is activated to become sticky, such as by heating or by activating with a reacting agent. For example, adhesive layer 20 may include a water-activated glue that is initially non-adhesive but becomes adhesive when activated with water. In the explanatory embodiment depicted, adhesive layer 20 includes an adhesive portion 22 having an inner surface 23 that adheres to substrate 14 (i.e., at upper surface 15 or lower surface 16), and an opposite adhesive outer surface 24 that is covered with a removable non-adhesive cover 26 for protecting adhesive layer 20 until needed. By way of example, non-adhesive cover 26 is a standard tape cover material, such as wax paper or the like.

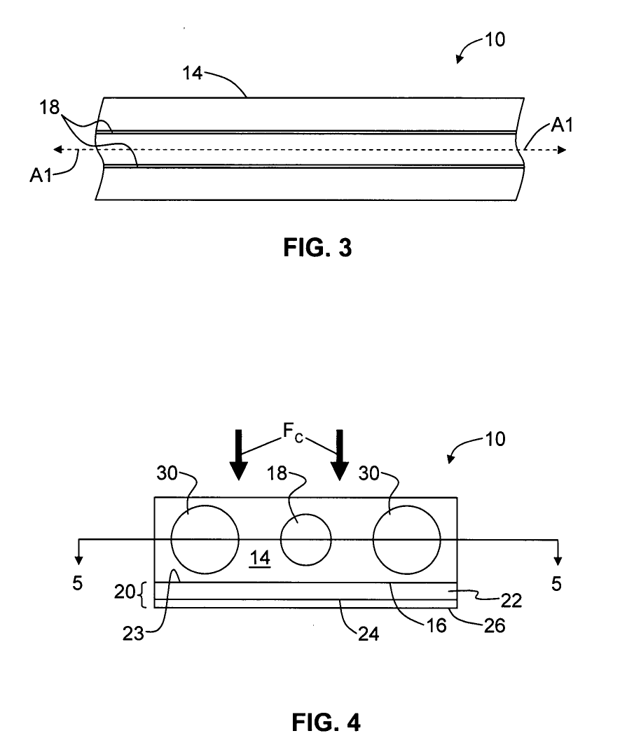

FIG. 3 is a longitudinal cross-sectional view of tape 10 of FIG. 2A taken along the line 3-3. In general, one or more optical fibers 18 run longitudinally down a length of substrate 14, meaning that while there may be one or more curves in the one or more optical fibers, the net optical path taken by signal in the one or more optical fibers is along the length of the tape. FIG. 3 illustrates an example embodiment of tape 10 wherein the one or more optical fibers 18 run substantially parallel to longitudinal axis A1; however, other configurations are possible.

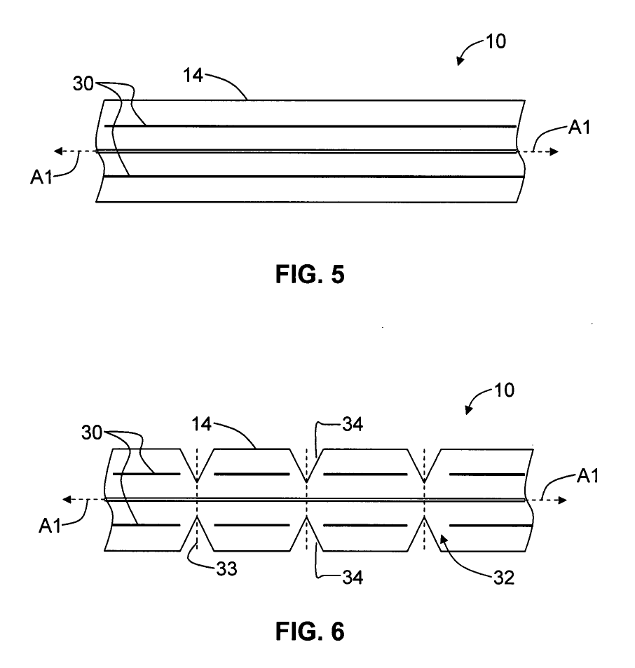

FIG. 4 is a longitudinal cross-section view of tape 10 similar to FIG. 2, but illustrating another example embodiment of the tape that includes one or more strength members 30 for providing mechanical protection to the optical fiber 18 in the tape. Like the optical fibers 18, strength members 30 may be disposed on or in substrate 14. Moreover, strength members 30 can have any suitable spacing and/or arrangement. Also, tape 10 of FIG. 4 is shown with one adhesive layer 20 and one optical fiber for the sake of illustration. As depicted, strength members 30 have a diameter slightly larger than that of optical fiber 18 so that a crushing force F_{C} applied to the tape is first absorbed by the strength members rather than the optical fiber(s). Additionally, strength members 30 also add to the tensile strength of tape 10. Example materials for strength members 30 include polyethylene (PE), glass-reinforced plastic (GRP), aramid-reinforced plastic (ARP) or metal wires such as steel, copper, copper-clad steel, etc or other suitable materials. Strength members 30 are also preferably sufficiently malleable so that the flexibility of the tape is not substantially impaired. Additionally, if suitable metallic strength members are used they can be used for carrying an electrical signal. FIG. 5 is a longitudinal cross-sectional view of tape 10 of FIG. 4, taken along the line 5-5 therein showing that strength members 30 run substantially parallel to longitudinal axis A1, but variations are possible.

Other variations having strength members according to the present invention are also possible. FIG. 6 is a longitudinal cross-sectional view similar to that of FIG. 5, but illustrating an example embodiment wherein the one or more strength members 30 each have gaps 32 located along corresponding “fold” lines 33 perpendicular to longitudinal axis A1 such that tape 30 can be folded along each fold line 33. Further, the example in FIG. 6 includes a plurality of corresponding opposing notches 34 are formed in substrate 14 and arranged along fold lines 33 so that tape 10 has add flexibility at select locations along its length. However, the strength members in this embodiment, generally speaking, provide crush protection, but not tensile strength since they are discontinuous. Tensile strength could be provided by positioning the strength members beneath the fold gaps such as they are continuous.

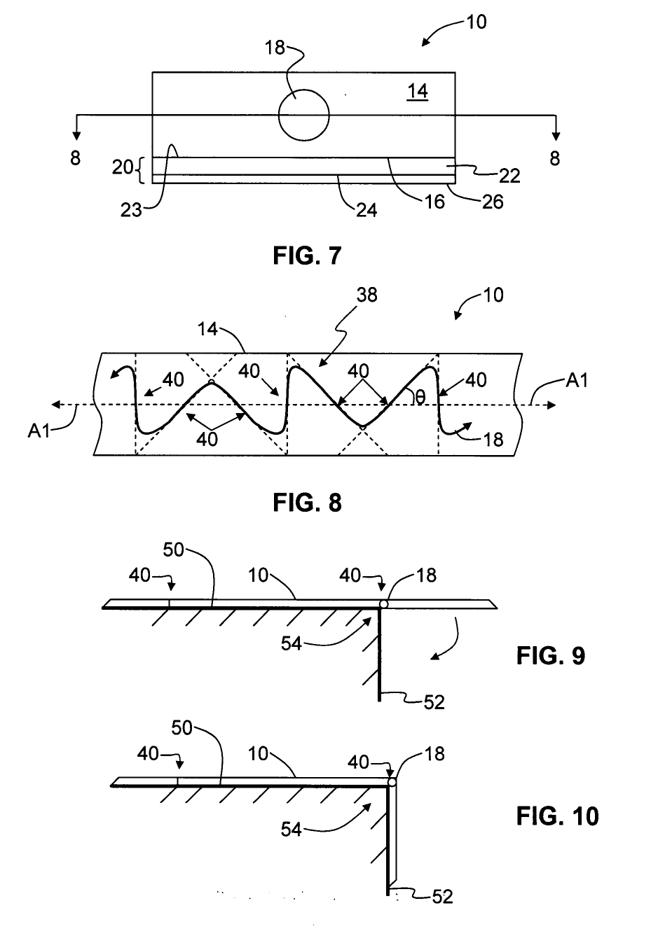

FIG. 7 is a cross-sectional diagram similar to that of FIG. 4, but illustrating an example embodiment wherein tape 10 that has a single optical fiber with a curved path 38 and a single adhesive layer 20. FIG. 8 is a longitudinal cross-sectional view taken along the line 8-8 in FIG. 7, illustrating the curved path 38 of optical fiber 18 along the substrate 14. As shown, the curved path 38 includes one or more sections 40 where optical fiber 18 travels at an angle relative θ to central longitudinal axis A1. Still, optical fiber curved path 38 is generally longitudinal along the length of tape 10 (i.e., the curved path follows the tape). Angle θ is generally in the range 90°≧θ>0° so the optical fiber path is longer than the tape. By way of example, curved path 38 includes one or more sections 40 having an angle θ between about 65° and about 85° relative to longitudinal axis A1, but other angles in the range are possible so long as the mechanical and optical performance of the optical fiber is preserved. Providing a curved path for the optical fiber along the length of the tape provides advantages during installation as discussed below.

FIG. 9 is a schematic plan view of two intersecting walls 50 and 52 that form an outside corner 54. Tape 10 is shown deployed along (i.e., adhered to) wall 50 so that a θ=90° section 40 of optical fiber curved path 38 is generally aligned falls at the outside corner 54. This positioning leads to optical fiber 18 running along outside corner 54 rather than perpendicular to the corner. Thus, when tape 10 is bent around outside corner 54 and adhered to wall 52 as shown in FIG. 10, optical fiber 18 does not sustain a sharp bend that can cause optical attenuation. Rather, optical fiber 18 maintains optical fiber curved path 38 and thus maintains its original transmission properties. Additionally, the concepts of a curved path provide a similar benefit for inside corners. Likewise, the curved path of the optical fiber has benefits when folding the tape on itself.

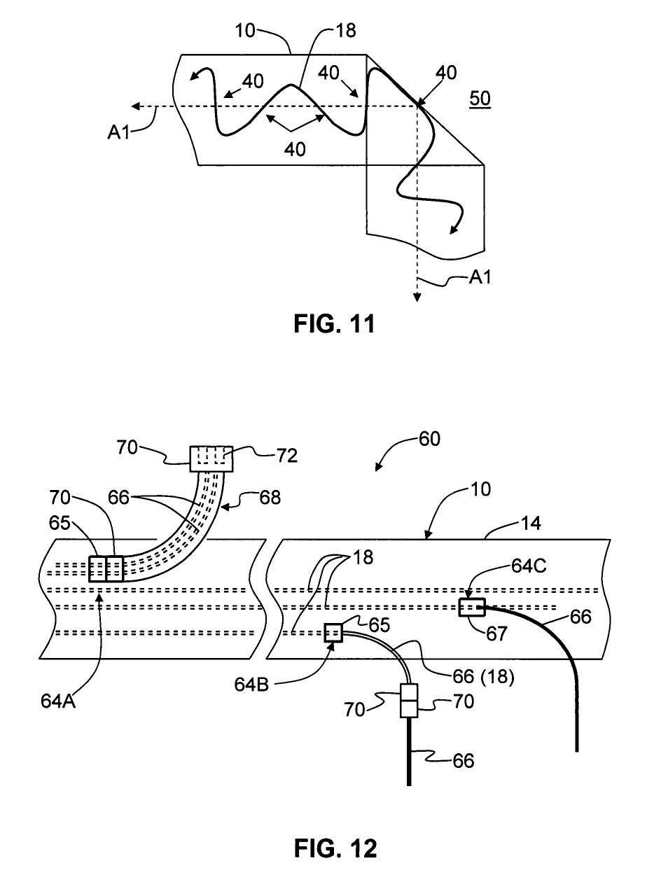

FIG. 11 is a longitudinal cross-sectional view of a tape 10 similar to that of FIG. 8, but showing tape 10 adhered to flat wall 50 and folded along section a θ=45° section 40 to form a right-angle bend that stays flat with the plane of the wall. Because optical fiber 18 lies along the 45° fold line (i.e., the dotted 45° line), the optical fiber does not sustain a sharp bend that can cause optical attenuation. Rather, optical fiber 18 maintains a curved path 38 on the tape and thus preserves its optical performance.

FIG. 12 is a schematic plan view of an example embodiment of a number different sections of an example distribution cable assembly 60 based on tape 10. Distribution cable assembly 60 includes tape 10 having at least one optical fiber 18 (referred to hereinbelow as a “tape optical fiber” when necessary to distinguish from “external optical fibers,” discussed below), and preferably a plurality of tape optical fibers. Five such tape optical fibers 18 are shown in tape 10 of FIG. 12 for the sake of illustrating different example embodiments of network access points NAPs for distribution cable assemblies. Generally speaking, NAPs provide distribution of one or more tape optical fibers 18 for optical communication toward the subscriber. For instance, the tape optical fibers are in optical communication with at least one external optical fiber or directly to other hardware such as connector or the like attached to the tape optical fiber.

As shown, distribution cable assembly 60 illustrates three different explanatory configurations for NAPs 64A, 64B, and 64C located along tape 10. Generally speaking, the NAP may include at least one external optical fiber 66 in optical communication with a tape optical fiber at the NAP or the tape optical fiber can have a predetermined length routed away (i.e., presented apart from the tape) from the NAP as a tap point for optical communication. The example embodiment on the left hand side depicts a NAP 64A having at least one fiber optic joining point between the tape optical fiber and the external optical fiber 66 that is a portion of an optical fiber tether 68. The fiber optic joining point may include any suitable joining point 65 such as a fusion splice or a connector attached to the tape optical fiber 66 that mates with a corresponding connector of the external optical fiber. As depicted, NAP 64A includes a connector 65 attached to the tape optical fiber that mates with a connector 70 that is attached to the external optical fiber 66 of optical fiber tether 68. Of course, optical fiber tether 68 could have a pigtail optical fiber for fusion splicing on one end instead of a connector 70. NAP 64B shows the tape optical fiber 18 presented as an optical tap point (i.e., the tape optical fiber presented apart from the tape) that includes a connector 70 thereon for plug and play connectivity with an external optical fiber 66 having a (mating) connector 70 attached thereto. The example embodiment on the right side depicts a NAP 64C having at least one optical tap 67 (i.e., the tape optical fiber presented apart from the tape) that can connect to the at least one external optical fiber 66 or otherwise be attached, spliced, or the like to suitable structures. In other words, the tape optical fiber is routed away from the tape for a predetermined distance.

In the case where external optical fibers are a portion of an optical fiber tether 68, the optical fiber tether may be a portion of any suitable fiber optic cable or a tubular body. As is well known in the optical fiber connecting art, optical fibers 66 of tether 68 and the associated distribution cable 60 may be spliced or otherwise connected together in any manner, such as by fusion or mechanical splicing, either individually or in mass. Moreover, tether optical fibers or tether optical cables may have any predetermined length, for example, 15, 25, 50, 100 and 100+ feet, among others.

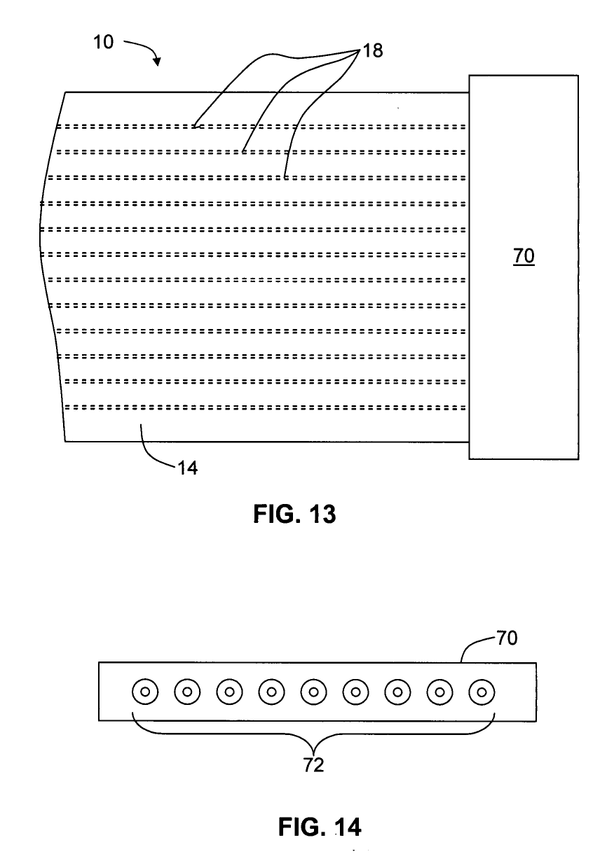

Additionally, other distribution cable assemblies based on the tapes of the present invention are possible. For instance, the upstream end (i.e., the end closest to the central office) of the tape may be preconnectorized for plug and play connectivity. Illustratively, FIG. 13 is a plan view of an example embodiment of a portion of tape 10 that includes a multifiber connector 70 at tape end 12. FIG. 14 is an end-view of multi-fiber connector 70. Connector 70 of FIGS. 13 and 14 is advantageous since it allows a quick and simple fiber optic joining point for making an optical connection with multiple optical fibers of tape 10.

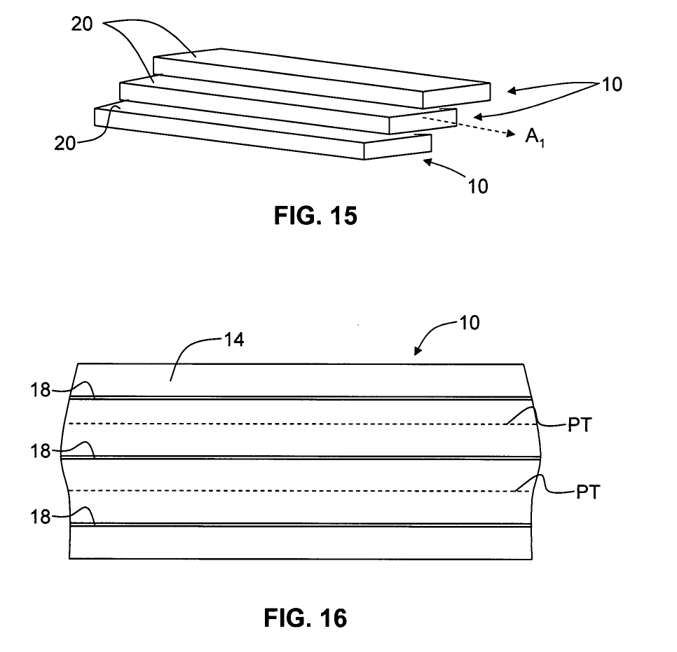

Other embodiments of the present invention can include tapes or tape assemblies that have a portion that is detachable for distributing optical fibers along the length of the tape. For instance, FIG. 15 is a perspective view illustrating an example embodiment of the optical fiber tape of the present invention wherein two or more tapes 10 are layered substantially along longitudinal axis A1 so that the different tape layers at least partially overlap. Adhesive layers 20 serve to removably adhere the different tape layers, so that the tape layers can be separated from one another and used, for example, to deploy the corresponding optical fibers 18 in different directions. In other words, a predetermined portion of one of the tapes is peeled away from the assembly of tapes and routed to an appropriate location. FIG. 16 is a perspective view of another optical fiber tape of the present invention where a portion of the substrate is detachable along the longitudinal axis. In this embodiment, tape 10 of FIG. 16 includes one or more preferential tear characteristics PT for separating a portion of substrate 14 so that optical fiber 18 is deployable in a different direction from the remaining portion of tape 10. For instance, preferential tear characteristics can be an integral portion of a fabric, mesh, or weave that forms a portion of the substrate (i.e., a portion of the substrate has a preferential tear characteristic along the longitudinal axis). Likewise, the preferential tear characteristics can be provided by perforating of otherwise weakening the substrate such as using stress concentrators or the like.

Any of the tapes 10 or assemblies of the invention such as tethers 34 or the like may include flame-retardant elements for meeting indoor rating applications. By way of example, the substrate 14 may be one or more of suitable papers, fabrics, polymers, vinyls, cellophane, or other like material for helping meet the desired rating. In other words, tape 10 at least meets a general purpose flame-rating according to ANSI/UL-1581, but other ratings are possible. For instance, tape 10 and the distribution cable assembly 60 made therefrom may meet or exceed the UL1666 flame test for riser applications, a test for flame propagation height of electrical and optical fiber cables installed vertically in shafts. The tape and related distribution cable assembly also may meet or exceed the NFPA 262 flame test, the standard method of test for flame travel and smoke of wires and cables for use in air-handling spaces. The tape and related distribution cable assemblies may include OFNR interior cables and NAPs that do not contain electrically conductive components and which are certified for use in riser applications to prevent the spread of fire from floor to floor in an MDU and are ANSI/UL 1666-1997 compliant. The tape and related distribution cable assembly may also be run in the plenum spaces of buildings typically used for air circulation in heating and air conditioning systems, typically between the structural ceiling and the dropped ceiling or under a raised floor. Accordingly, the tape and related distribution cable materials and their respective NAPs of the present invention preferably meet or exceed the NFPA 90A standard or the like, the standard for the installation of air conditioning and ventilating systems. The tapes an/or assemblies may also be low smoke zero halogen (LSZH) compliant so they do not produce a Halogen gas when burned.

For meeting these flame requirements, tapes and/or assemblies of the invention can use one or more flame-retardant materials such as a substrate that includes one or more flame-retardant materials selected from the group of flame-retardant materials consisting of: fillers, tapes, spray on or paintable coatings, woven or composite glass polymer mantles, additives, brominated additives, inert mineral fillers, hydrated mineral fillers, mixtures of alkaline salts and polyphosphate compounds, flame inhibiting silicone processing and hydrated mixed-metal carbonates. Of course, other methods of making a flame-retardant tape or assembly are possible. For instance, other flame retarding methods may involve coating the tape with a flame barrier material. This could be a tape or wrap that acts as a flame barrier. These could be glass, polyetherimide (e.g., a Kapton tape available from DuPont) or mica tape. Also, a coating could be applied like the NO-BURN material which can be sprayed on or in the form of a latex paint.

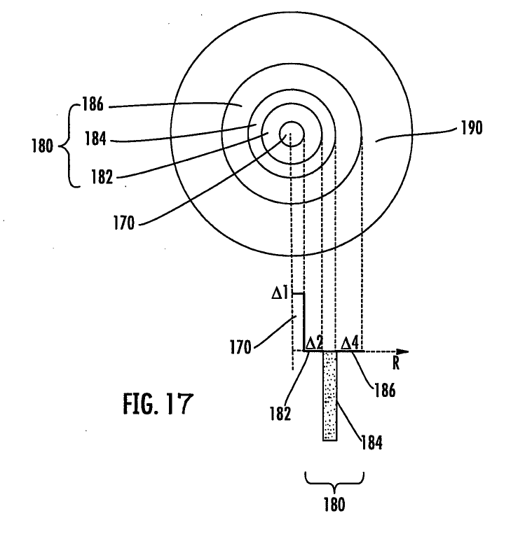

The tape and related distribution cable assembly of the present invention may include any optical fiber type including, but not limited to, single mode, multi-mode, bend performance fiber, bend optimized fiber and bend insensitive optical fiber. FIG. 17 is a cross-sectional view of an example optical fiber 18 illustrating a representation of a bend-performance optical fiber suitable for use in tape 10 and the related distribution cable assembly of the present invention. The optical fiber of FIG. 17 is advantageous in that allows tape 10 and the related distribution cable assembly to have aggressive bending characteristics while optical attenuation remains extremely low. As shown, bend-performance optical fiber 18 of FIG. 17 is a microstructured optical fiber having a core region 170 and a cladding region 180 surrounding the core region, the cladding region comprising concentric annular regions 182, 184 and 186. Annular region 184 is comprised of non-periodically disposed holes such that the optical fiber is capable of single mode transmission at one or more wavelengths in one or more operating wavelength ranges. The core region and cladding region provide improved bend resistance, and single mode operation at wavelengths preferably greater than or equal to 1500 nm, in some embodiments also greater than about 1310 nm, in other embodiments also greater than 1260 nm. The example optical fiber 18 of FIG. 17 provides a mode field at a wavelength of 1310 nm preferably greater than 8.0 microns, more preferably between about 8.0 and 10.0 microns. In preferred embodiments, optical fiber 18 of FIG. 17 is a single-mode transmission optical fiber.

In some embodiments, the microstructured optical fiber 18 of FIG. 17 comprises a core region disposed about a longitudinal centerline, and a cladding region surrounding the core region, the cladding region comprising an annular hole-containing region comprised of non-periodically disposed holes, wherein the annular hole-containing region 184 has a maximum radial width of less than 12 microns, the annular hole-containing region has a regional void area percent of less than about 30 percent, and the non-periodically disposed holes have a mean diameter of less than 1550 nm.

By “non-periodically disposed” or “non-periodic distribution”, we mean that when one takes a cross-section (such as a cross-section perpendicular to the longitudinal axis, as shown in FIG. 17) of the optical fiber, the non-periodically disposed holes are randomly or non-periodically distributed across a portion of the fiber. Similar cross sections taken at different points along the length of the fiber will reveal different cross-sectional hole patterns, i.e., various cross-sections will have different hole patterns, wherein the distributions of holes and sizes of holes do not match. That is, the holes are non-periodic, i.e., they are not periodically disposed within the fiber structure. These holes are stretched (elongated) along the length (i.e. in a direction generally parallel to the longitudinal axis) of the optical fiber, but do not extend the entire length of the entire fiber for typical lengths of transmission fiber.

For a variety of applications, it is desirable for the holes to be formed such that greater than about 95% of and preferably all of the holes exhibit a mean hole size in the cladding for the optical fiber which is less than 1550 nm, more preferably less than 775 nm, most preferably less than 390 nm. Likewise, it is preferable that the maximum diameter of the holes in the fiber be less than 7000 nm, more preferably less than 2000 nm, and even more preferably less than 1550 nm, and most preferably less than 775 nm. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes. The hole number, mean diameter, max diameter, and total void area percent of holes can all be calculated with the help of a scanning electron microscope at a magnification of about 800× and image analysis software, such as ImagePro, which is available from Media Cybernetics, Inc. of Silver Spring, Md., USA.

The example optical fibers 18 as used herein may or may not include germania or fluorine to also adjust the refractive index of the core and or cladding of the optical fiber, but these dopants can also be avoided in the intermediate annular region 184 and instead, the holes (in combination with any gas or gases that may be disposed within the holes) can be used to adjust the manner in which light is guided down the core of the fiber. The hole-containing region 184 may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes.

In one set of embodiments, the core region 170 includes doped silica to provide a positive refractive index relative to pure silica, e.g. germania doped silica. The core region is preferably hole-free. As illustrated in FIG. 17, in some embodiments, the core region 170 comprises a single core segment having a positive maximum refractive index relative to pure silica Δ₁ in %, and the single core segment extends from the centerline to a radius R₁. In one set of embodiments, 0.30%<Δ₁<0.40%, and 3.0 μm<R₁<5.0 μm. In some embodiments, the single core segment has a refractive index profile with an alpha shape, where alpha is 6 or more, and in some embodiments alpha is 8 or more. In some embodiments, the inner annular hole-free region 182 extends from the core region to a radius R₂, wherein the inner annular hole-free region has a radial width W12, equal to R2−R1, and W12 is greater than 1 μm. Radius R2 is preferably greater than 5 μm, more preferably greater than 6 μm. The intermediate annular hole-containing region 184 extends radially outward from R2 to radius R3 and has a radial width W23, equal to R3−R2. The outer annular region 186 extends radially outward from R3 to radius R4. Radius R4 is the outermost radius of the silica portion of the optical fiber. One or more coatings may be applied to the external surface of the silica portion of the optical fiber, starting at R4, the outermost diameter or outermost periphery of the glass part of the fiber. The core region 170 and the cladding region 180 are preferably comprised of silica. The core region 170 is preferably silica doped with one or more dopants. Preferably, the core region 170 is hole-free. The hole-containing region 184 has an inner radius R2 which is not more than 20 μm. In some embodiments, R2 is not less than 10 μm and not greater than 20 μm. In other embodiments, R2 is not less than 10 μm and not greater than 18 μm. In other embodiments, R2 is not less than 10 μm and not greater than 14 μm. Again, while not being limited to any particular width, the hole-containing region 184 has a radial width W23 which is not less than 0.5 μm. In some embodiments, W23 is not less than 0.5 μm and not greater than 20 μm. In other embodiments, W23 is not less than 2 μm and not greater than 12 μm. In other embodiments, W23 is not less than 2 μm and not greater than 10 μm.

Such fiber can be made to exhibit a fiber cutoff of less than 1400 nm, more preferably less than 1310 nm, a 20 mm macrobend induced loss at 1550 nm of less than 1 dB/turn, preferably less than 0.5 dB/turn, even more preferably less than 0.1 dB/turn, still more preferably less than 0.05 dB/turn, yet more preferably less than 0.03 dB/turn, and even still more preferably less than 0.02 dB/turn, a 12 mm macrobend induced loss at 1550 nm of less than 5 dB/turn, preferably less than 1 dB/turn, more preferably less than 0.5 dB/turn, even more preferably less than 0.2 dB/turn, still more preferably less than 0.01 dB/turn, still even more preferably less than 0.05 dB/turn, and a 8 mm macrobend induced loss at 1550 nm of less than 5 dB/turn, preferably less than 1 dB/turn, more preferably less than 0.5 dB/turn, and even more preferably less than 0.2 dB-turn, and still even more preferably less than 0.1 dB/turn.

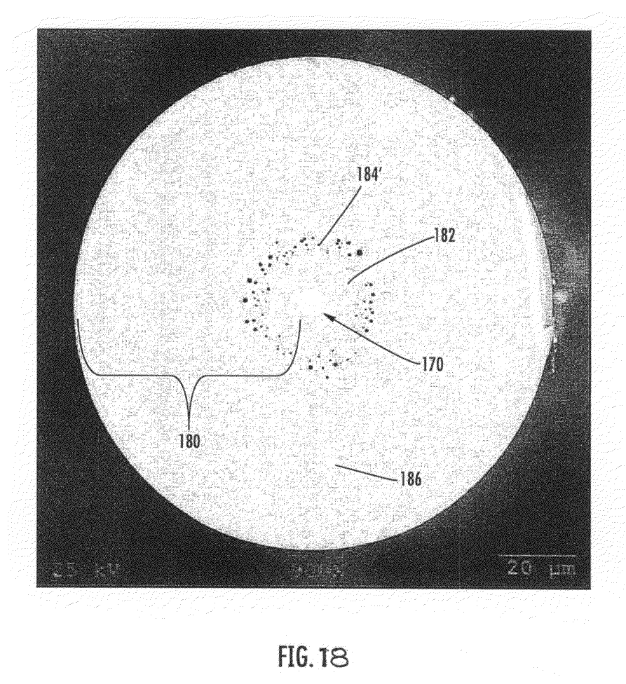

One example of a suitable fiber is illustrated in the cross-sectional view of FIG. 18, and comprises core region 170 that is surrounded by a cladding region 180 that comprises randomly disposed voids which are contained within an annular region 184′ spaced from the core and positioned to be effective to guide light along the core region. Other optical fibers and microstructured fibers may be used in the present invention. Additional description of microstructured fibers used in the present invention are disclosed in pending U.S. patent application Ser. No. 11/583,098 filed Oct. 18, 2006; and, Provisional U.S. patent application Ser. Nos. 60/817,863 filed Jun. 30, 2006; 60/817,721 filed Jun. 30, 2006; 60/841,458 filed Aug. 31, 2006; and 60/841,490 filed Aug. 31, 2006; all of which are assigned to Corning Incorporated; and incorporated herein by reference.

The present invention provides various embodiments of a flexible optical fiber tape and a related distribution cable assembly having one or more NAP locations at which corresponding one or more tethers 68 can be used to extend the network to a location within reach of tether. The flexible optical fiber tape is well-suited for indoor applications because it is generally flat and may have at least one adhesive surface that can be used to adhere the tape to an interior wall in an unobtrusive manner. Because of its low profile, the tape can be routed along the floors, walls and ceilings of a room, as well through otherwise tight areas such as window-frames and door-frames. Furthermore, the tape can be run around corners and be bent while still maintaining the performance of the optical fibers therein. In the case where the tape includes an optical fiber having a relatively large minimum bend radius, the optical fiber can be arranged to have an optical fiber curved path so that bending the tape at select locations does not result in a bending of the optical fiber beyond its allowed bending radius. In the case where the optical fibers are bend-insensitive, the tape can have multiple optical fibers that run longitudinally and that can be attached to tethers at NAP locations along the tape so that the optical fibers in the tape can be optically coupled with external optical fibers. This is facilitated by the tape optical fibers and the external optical fibers being pre-connectorized.

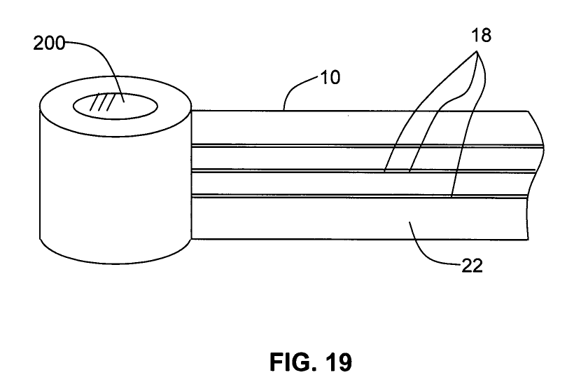

Additionally, using bend performance optical fibers or other suitable optical waveguides in tape 10 allows convenient packaging and quick deployment for the craft. For instance, FIG. 19 depicts a tape 10 having a first adhesive portion 22 used for packaging the same and/or other assembly onto a dispensing reel 200. More specifically, tape 10 shown in FIG. 19 apparatus is packaged using the first adhesive layer for securing the same to dispensing reel 200 and then to an external surface. Dispensing reel 200 is sized for removably attaching to a tape dispenser that the craft can use to attach tape 10 in a continuous fashion along a wall or the like. Of course, other tape variations such as assemblies having NAP locations, connectors, and the like may also employ this type of packaging. Moreover, since tape 10 is relatively thin dispensing reel 200 can hold relatively long lengths of the same for the craft. Other variations of this concept are also possible. Illustratively, after securing tape 10 to the wall or the like a second tape such as a protective tape, a flame-retardant substance, or a decorative tape could be applied thereover.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. For example, other network components may be used in combination with the tape and distribution cable assembly of the present invention. Material, flame retardant and physical properties of the tape and related distribution cable assembly may be enhanced or relaxed depending on their intended use.

1. An optical-fiber-based tape apparatus, comprising:
a substrate in the form of a strip having opposing upper and lower surfaces and a central longitudinal axis;
at least one optical fiber maintained by the flame-retardant substrate, wherein the apparatus meets at least a general purpose flame-rating according ANSI/UL-1581.

2. The apparatus of claim 1, further including a first adhesive layer, the first adhesive layer formed on one of the upper and lower surfaces for fixing the apparatus to an external surface.

3. The apparatus of claim 1, wherein the at least one optical fiber is either (a) maintained between the upper and lower surfaces or (b) attached to one of the upper or lower surfaces.

4. The apparatus of claim 1, the flame-retardant substrate being selected from the set of of a paper, a plastic, a fabric, a mesh, a strand, a roving, a cellophane, a vinyl, a UV curable material, and combinations thereof.

5. (canceled)

6. (canceled)

7. (canceled)

8. (canceled)

9. The apparatus of claim 1, wherein the at least one optical fiber has a path having one or more curves.

10. (canceled)

11. The apparatus of claim 1, wherein the at least one optical fiber is a microstructured optical fiber.

12. The apparatus of claim 1, wherein the flame-retardant substrate includes one or more flame-retardant materials selected from the group of flame-retardant materials consisting of: fillers, tapes, spray on or paintable coatings, woven or composite glass polymer mantles, additives, brominated additives, inert mineral fillers, hydrated mineral fillers, mixtures of alkaline salts and polyphosphate compounds, flame inhibiting silicone processing and hydrated mixed-metal carbonates.

13. The apparatus of claim 1, further including a fiber optic connector wherein the fiber optic connector is attached to the at least one optical fiber.

14. The apparatus of claim 1, further including a plurality of optical fibers maintained by the flame-retardant substrate, wherein the flame-retardant substrate has a preferential tear characteristic for separating a portion of the flame-retardant substrate.

15. (canceled)

16. (canceled)

17. (canceled)

18. The apparatus of claim 1, further including a first adhesive layer so that the optical-fiber based tape apparatus is packaged on a dispensing reel using the first adhesive layer for facilitating securing the tape to an external surface.

19. An optical-fiber-based tape apparatus, comprising:
a substrate being a composite of two or more materials having opposing upper and lower surfaces and a central longitudinal axis;
a plurality of one optical fibers maintained by the substrate, wherein the plurality of optical fibers are arranged in a plurality of groups of one or more optical fibers, wherein the one or more groups of optical fibers have a predetermined spacing and a preferential tear characteristic is disposed between the one or more groups of optical fibers, thereby allowing separation of a portion of the substrate for providing one or more optical fibers at a network access point.

20. An optical-fiber-based tape apparatus, comprising:
at least one substrate in the form of a longitudinal strip having a longitudinal axis;
a plurality of optical fibers maintained by the at least one substrate, wherein a portion of the substrate has one or more of the individual optical fibers and the portion of the substrate is detachable along the longitudinal axis so that the one or more individual optical fibers can be provided at one or more network access points along the longitudinal strip.

21. The apparatus of claim 20, the apparatus further including a plurality of substrates where the substrates are attached together so that adjacent substrate surfaces at least partially overlap and are removable along the longitudinal axis so that the one or more optical fibers can be provided at one or more network access points.

22. The apparatus of claim 20, wherein the at least one substrate includes one or more preferential tear portions for separating a portion of the substrate so that one or more optical fibers are detachable along the longitudinal axis of the at least one substrate for providing one or more optical fibers at a network access point.

23. The apparatus of claim 20, wherein the at least one substrate is flame-retardant and selected from the set of a paper, a plastic, a fabric, a mesh, a strand, a roving, a cellophane, a vinyl, a UV curable material, and combinations thereof.

24. The apparatus of claim 23, wherein the flame-retardant substrate includes one or more flame-retardant materials selected from the group of flame-retardant materials consisting of: fillers, tapes, spray on or paintable coatings, woven or composite glass polymer mantles, additives, brominated additives, inert mineral fillers, hydrated mineral fillers, mixtures of alkaline salts and polyphosphate compounds, flame inhibiting silicone processing and hydrated mixed-metal carbonates.

25. (canceled)

26. The apparatus of claim 20, wherein the at least one optical fiber is either (a) maintained between an upper and a lower surface of the substrate or (b) attached to one of the upper or lower surfaces of the substrate.

27. (canceled)

28. The apparatus of claim 20, further including an adhesive layer on the substrate for attaching the apparatus to an external surface.

29. The apparatus of claim 20, wherein the at least one of the plurality of optical fibers is a microstructured optical fiber.

30. The apparatus of claim 20, further including a first adhesive layer so that the optical-fiber based tape apparatus is packaged on a dispensing reel using the first adhesive layer for facilitating securing the tape to an external surface.

31. The apparatus of claim 20, further including a fiber optic connector wherein the fiber optic connector is attached to at least one of the plurality of optical fibers.

32. (canceled)

33. A distribution cable assembly, comprising:
a flame-retardant substrate in the form of a strip having opposing upper and lower surfaces and a central longitudinal axis;
a plurality of optical fibers maintained by the flame-retardant substrate;
a first adhesive layer formed on one of the upper and lower surfaces for fixing the apparatus to an external surface; and
a network access point (NAP) formed in the distribution cable assembly where at least one optical fiber is routed away from the central longitudinal axis for distribution.

34. The assembly of claim 33, wherein the assembly meets at least a general purpose flame-rating according ANSI/UL-1581.

35. The assembly of claim 33, the assembly being packaged on a dispensing reel using the first adhesive layer for facilitating securing the tape to an external surface.

36. (canceled)

37. (canceled)

38. The assembly of claim 33, wherein the NAP includes an optical fiber tether in optical communication with the at least one optical fiber for distribution.

39. (canceled)
